(19) United States
(12) Patent Application Publication
(10) Pub. No.: US 2018/0053994 A1
(43) Pub. Date: Feb. 22, 2018

(54) Electronically Compensated Radome Using Frequency Selective Surface Compensation

(71) Applicant: L-3 Communications Corporation, New York, NY (US)

(72) Inventors: Maurio Batista GRANDO, McKinney, TX (US); George Zohn HUTCHESON, Richardson, TX (US)

(73) Assignee: L-3 Communications Corporation, New York, NY (US)

(21) Appl. No.: 15/242,983

(22) Filed: Aug. 22, 2016

(51) Int. Cl. H01Q 1/42; H01Q 1/28; H01Q 1/48

(52) U.S. Cl. CPC H01Q 1/425; H01Q 1/48; H01Q 1/281

(57) ABSTRACT

An apparatus for compensating for distortions in RF beams caused by a radome. The apparatus comprises: i) a plurality of metal patches arranged in rows and columns; ii) a first plurality of varactors coupling adjoining ones of a first plurality of metal patches in a first row of metal patches; and iii) a first reference voltage source configured to apply a first reference voltage to the first plurality of metal patches in the first row. The apparatus further comprises: iv) a second plurality of varactors coupling adjoining ones of a second plurality of metal patches in a first column of metal patches; and v) a second reference voltage source configured to apply a second reference voltage to the second plurality of metal patches in the first column. The first and second reference voltage sources adjust the phase delays of RF beams passing through each metal patch in the rows and columns.

### TECHNICAL FIELD

The present application relates generally to radomes and, more specifically, to a technique for compensating for radar pattern distortion.

### BACKGROUND

Airborne radar antennas are generally placed in the noses of missiles or aircraft in order to detect and monitor targets ahead of the vehicle. The antennas are placed inside of an aerodynamically shaped radome composed of a dielectric material with sufficient strength to withstand the mechanical stresses of flight while minimizing the energy loss to the radar signal. However, the aerodynamic shape of the dielectric radome cause distortions in the beam shape and gain of the radar antenna. This is analogous to the distortion of an optical image by a warped lens. As a result, radomes on airborne platforms often cause beam pointing errors, beam-shape distortion, and high side-lobes for array antennas—both fixed and phased arrays.

To avoid enemy detection, many radomes are covered with one or more frequency selective surfaces (FSS). Each FSS is typically an array of regularly or irregularly spaced metal patches on the radome surface or embedded within the radome material that are engineered to control the transmission and reflection of radar signals by the radome. A radome with an FSS may be designed so that it is difficult to detect by enemy radar (i.e., low observable or LO), but allows easy passage of radar signals to and from the antenna within the radome. However, the FSS itself may cause additional distortion of the radar antenna beam shape and gain.

For phased arrays, these distortions are typically corrected electronically by carefully adjusting the phase and/or amplitude of each antenna element to achieve the desired antenna beam-width, side-lobe levels, and pointing accuracy. The degree to which the phase and amplitude may be adjusted to compensate for a radome is often limited by the electronics of the antenna/radar and may not sufficiently correct for beam shape distortions. Further, correction of beam-shape via radar electronics complicates antenna beam-steering algorithms. This results in control schemes in which beam-steering and beam-shape correction are not independent functions. These algorithms are very difficult to design and determining phase and amplitude weights of an array to compensate for radome distortion is expensive, since the phase and amplitude of each element must be optimized for each pointing direction while minimizing beam-width and side-lobes. This is a multi-dimensional problem of a large number of variables.

For fixed arrays (possibly gimbal mounted), corrections are difficult since multiple variations of the corporate feed may need to be built and tested to ensure adequate performance. Computer simulations of corrections are difficult, since the size and scale of radomes are electronically large and require considerable computational resources.

Therefore, there is a need in the art for an improved radomes. In particular, there is a need for a radome that is capable of compensating for pattern distortion caused the arbitrary shape of the radome.

### SUMMARY

To address the above-discussed deficiencies of the prior art, it is a primary object to provide, for use in a radome, an apparatus for compensating for distortions in radio frequency (RF) beams caused by the radome. The apparatus comprises: i) a plurality of metal patches arranged in rows and columns; ii) a first plurality of varactors coupling adjoining ones of a first plurality of metal patches in a first row of metal patches; and iii) a first reference voltage source configured to apply a first reference voltage to the first plurality of metal patches in the first row. The first reference voltage source adjusts the phase delay of a portion of an RF beam passing through each of the first plurality of metal patches in the first row by controlling a voltage or a current at each varactor to thereby generate electrical phase delays between the adjoining ones of the first plurality of metal patches in the first row.

In one embodiment, the apparatus further comprises a first row fine phase step controller configured to couple a first one of the first plurality of metal patches in the first row to the first reference voltage source.

In another embodiment, the apparatus further comprises a second row fine phase step controller configured to couple a second one of the first plurality of metal patches in the first row to a ground.

In still another embodiment, the apparatus further comprises: iv) a second plurality of varactors coupling adjoining ones of a second plurality of metal patches in a first column of metal patches; and v) a second reference voltage source configured to apply a second reference voltage to the second plurality of metal patches in the first column. The second reference voltage source adjusts the phase delay of a portion of an RF beam passing through each of the second plurality of metal patches in the first column by controlling a voltage or a current at each varactor to thereby generate electrical phase delays between the adjoining ones of the second plurality of metal patches in the first column.

In a further embodiment, the apparatus further comprises a first column fine phase step controller configured to couple a first one of the second plurality of metal patches in the first column to the second reference voltage source.

In a still further embodiment, the apparatus further comprises a second column fine phase step controller configured to couple a second one of the second plurality of metal patches in the first column to a ground.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a side view of a radome having a common nose cone shape according to one embodiment of the disclosure.

FIG. 2 illustrates a frequency selective surface (FSS) comprising a capacitive grid.

FIG. 3 illustrates a frequency selective surface (FSS) comprising an inductive grid.

FIG. 4A illustrates an exemplary electronically tunable frequency selective surface (FSS) for radome compensation according to one embodiment of the disclosure.

FIG. 4B illustrates an exemplary electronically tunable frequency selective surface (FSS) for radome compensation according to another embodiment of the disclosure.

FIG. 5 illustrates a side view of a radome with sections of constant phase according to one embodiment of the disclosure.

FIG. 6A illustrates distortion by an arbitrarily shaped radome that does not implement compensation.

FIG. 6B illustrates distortion by an arbitrarily shaped radome that implements compensation according to the principles of the present disclosure.

FIG. 7 is a graph of phase as a function of frequency and voltage for a reflect array design according to the principles of the present disclosure.

FIG. 8 is a graph illustrating a comparison of peak directivity with and without passive FSS according to the principles of the present disclosure.

### DETAILED DESCRIPTION

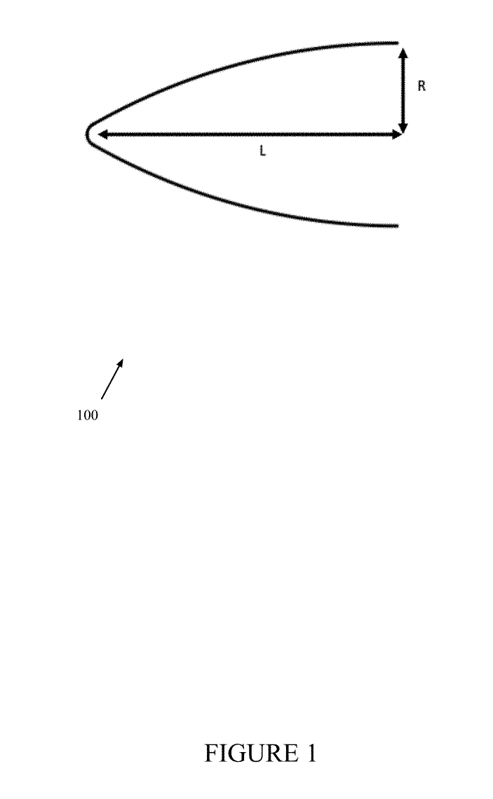

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged radome.

The present disclosure hereby incorporates by reference the following reference documents (REF1-REF5) as if fully set forth herein:

REF1—Dan Sievenpiper, et al., “Electronic Beam Steering Using a Varactor-Tuned Impedance Surface,” Antennas and Propagation Society International Symposium, 2001, IEEE.

REF2—I. Russo, et al., “Tunable Pass-Band FSS for Beam Steering Applications,” Antennas and Propagation (EuCap), 2010 Proceedings of the Fourth European Conference, IEEE.

REF3—B. Munk, “Frequency Selective Surfaces: Theory and Design”, John Wiley, 2000.

REF4—G. Z. Hutcheson, et al., “Wide Angle Beam Scanning At Millimeter Waves Using A Planar Lens,” IEEE Antennas and Propagation Society International Symposium (APSURSI), 2014.

REF5—J. Oh, G. Z. Hutcheson, et al., “Planar Beam Steerable Lens Antenna System Using Non-Uniform Feed Method,” IEEE Antennas and Propagation Society International Symposium (APSURSI), 2014.

The present disclosure provides a superior method for compensating for pattern distortion caused by an arbitrarily shaped radome. Frequency selective surface (FSS) material is interleaved with variable capacitors (varactors) and an analog voltage is used to control the phase gradient as electromagnetic waves interact at the radome interface. The present disclosure provides advantages for radars, sensors, and communication equipment placed in missiles and other aerial vehicles.

As noted above, transmission through radomes having arbitrary shapes in three-dimensions may result in beam shape distortion and beam pointing errors due to refraction. A radar beam traversing through an arbitrarily shaped radome may experience significant phase delays across the beam breadth causing beam shape distortion and pointing errors. These phase delays and losses may also vary over the extent of the oddly shaped radome, further exacerbating distortion and pointing errors as the beam scans across different pointing angles.

The disclosed electronically controlled frequency selective surface (FSS) provides a means to dynamically correct beam distortion and pointing errors by adjusting the phase delay through small FSS elements (or pixel or patch) covering the inside of the radome. A portion of the radar beam passes through a single FSS element/patch where the phase of that portion of the beam is adjusted to compensate for phase delay at that particular location on the radome due to shape or thickness variations.

Thus, the disclosed apparatus uses an electronically tuned or controlled frequency selective surface (FSS) to compensate for distortions in antenna beam shapes caused by an airborne radome. Antenna patterns are re-shaped by electronically changing the electromagnetic (EM) phase among the metal or conductive elements of the FSS. Phase control of EM waves is done in a similar way to that of the Sievenpiper reference document above (REF 1), where the phases of EM waves reflected from an electronically tuned impedance surface are controlled by varactor diodes. In the present disclosure, transmission through a surface is described rather than reflection. Also, REF5 above discloses beam-shape control for passive or fixed FSS structures.

FIG. 1 illustrates a side view of radome 100, which has a common nose cone shape according to one embodiment of the disclosure. Radome 100 has a length, L, and a radius, R. Typically, radome 100 houses electronic equipment, including one or more radio frequency (RF) transmitters. In particular, radome 100 may house radar transceivers that transmit directed beams that have a predetermined antenna pattern that may be distorted as the beams pass through the material of radome 100. The shape of radome 100 is FIG. 1 is by way of example only and should not be construed to limit the scope of the disclosure. In other embodiments, radome 100 may have other types of standard shapes, including: i) tangent ogive, ii) secant ogive, iii) spherically blunted tangent ogive, iv) elliptical, v) parabolic, vi) power series, vii) LV HAACK, viii) LD HAACK, ix) Von Karman ogive, and others.

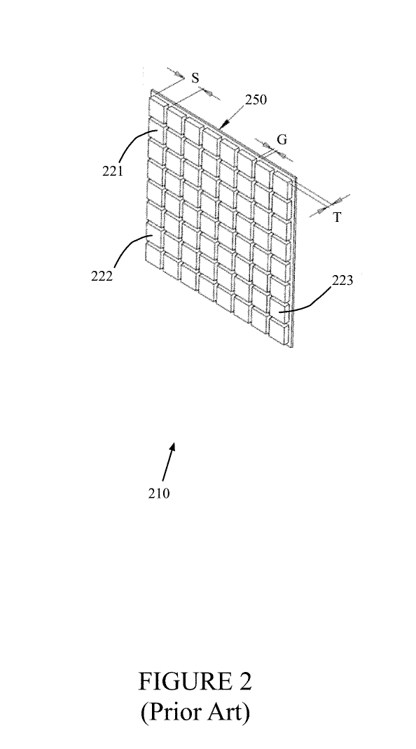

FIG. 2 illustrates a first exemplary frequency selective surface (FSS) comprising capacitive grid 210 according to one embodiment of the prior art. Capacitive grid 210 comprises a plurality of metal patches arranged in an R×C matrix containing R rows and C columns. The metal patches, including exemplary metal patches 221, 222, and 223, are mounted on supporting dielectric film 250. The metal patches have a cell spacing, S, a cell gap, G, and a thickness, T.

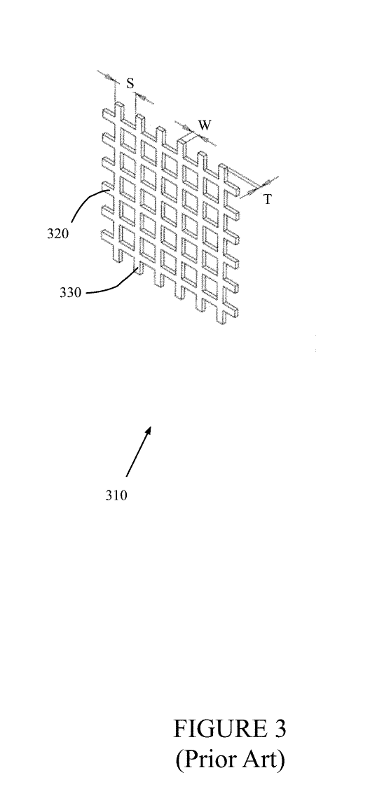

FIG. 3 illustrates a second exemplary frequency selective surface (FSS) comprising inductive grid 310 according to one embodiment of the prior art. Inductive grid 310 comprises a metal lattice that includes horizontal metal strips 320 and vertical metal strips 330 that define a matrix of apertures arranged in rows and columns. The metal strips have a cell spacing, S, a width, W, and a thickness, T.

Generally, a frequency selective surface is any thin, repetitive surface (e.g., screen on a microwave oven door) that reflects, transmits or absorbs electromagnetic fields as a function of the frequency. Frequency selective surfaces are most commonly used in applications such as microwave ovens, antenna radomes, and metamaterials.

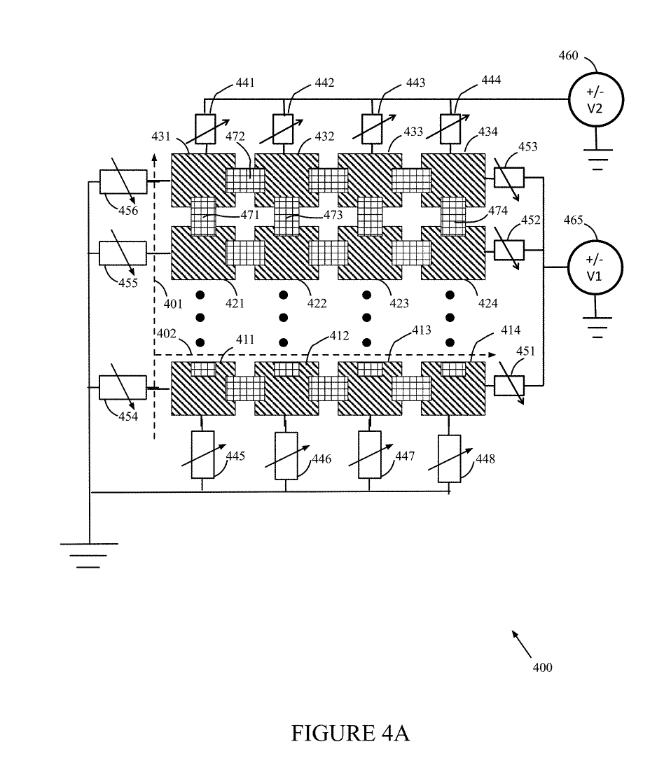

FIG. 4A illustrates exemplary electronically tunable frequency selective surface (FSS) 400 for radome compensation according to one embodiment of the disclosure. Electronically tunable frequency selective surface (FSS) 400 is a capacitive grid similar to FIG. 2 and is implemented as a matrix of metal patch elements arranged in R rows and C columns. FSS 400 comprises, among others, exemplary FSS metal patch elements 411-414 in a first row, exemplary FSS metal patch elements 421-424 in a second row and exemplary FSS metal patch elements 431-434 in a third row. FSS 400 also comprises horizontal fine phase step controllers 441-444 and 445-448, vertical fine phase step controllers 451-453 and 454-456, varactors 471-474, +/−V2 coarse phase control source 460, and +/−V1 coarse phase control source 465. Fine phase step controllers 441-448 and fine phase step controllers 451-456 may comprise, for example, variable resistors.

The metal patches in each row and in each column are coupled to each other by varactors. The first metal patch in each row is coupled to ground by one of fine phase step controllers 454-456. The last metal patch in each row is coupled by one of fine phase step controllers 451-453 to the +/−V1 voltage output by +/−V1 coarse phase control source 465. The first metal patch in each column is coupled to ground by one of fine phase step controllers 445-448. The last metal patch in each column is coupled by one of fine phase step controllers 441-444 to the +/−V2 voltage output by +/−V2 coarse phase control source 465.

The biasing voltages +/−V1 and +/−V2 provided by coarse phase control source 460 and coarse phase control source 465 help create vertical phase gradient direction 401 in each column of metal patches and horizontal phase gradient direction 402 in each row of metal patches. For example, in the first (bottom) row, horizontal phase gradient direction 402 is generated across metal patches 411-414 and the coupling varactors by +/−V1 coarse phase control source 465 and fine phase step controllers 454 and 451. Similarly, in the first (leftmost) column, vertical phase gradient direction 401 is generated across metal patches 411, 421, and 431 and the coupling varactors by +/−V2 coarse phase control source 460 and fine phase step controllers 445 and 441.

The phase shifts of RF beams transmitted through the metal patches in FSS 400 are determined not only by the size, thickness, and spacing of the metal patches, but also by the voltage differences between the metal patches. By controlling the voltage differences between each of the metal patches in FSS 400, it is possible to compensate for the phase shift distortions caused by the shape of radome 100, thereby providing flat phase fronts for different beam steering directions as programmed into the radome 100. The voltage differences between metal patches that create vertical phase gradient direction 401 and horizontal phase gradient direction 402 are determined by the values of the coupling varactors (e.g., varactors 471-474), the settings of the horizontal fine phase step controllers 441-448 and vertical fine phase step controllers 451-456, and the V1 and V2 reference voltage outputs of +/−V1 coarse phase control source 460 and +/−V2 coarse phase control source 465.

FIG. 4B illustrates exemplary electronically tunable frequency selective surface (FSS) 499 for radome compensation according to another embodiment of the disclosure. The operation of FSS 499 is very similar to the operation of FSS 400 except that horizontal fine phase step controllers 445-448 are replaced by varactors 491-494 and vertical fine phase step controllers 454-456 are replaced by varactors 481-483.

A frequency selective surface (e.g., FSS 400) according to the present disclosure may be printed or mounted to the inside of radome 100 or may be embedded within the radome 100 material. The varactor devices are connected (e.g., soldered) to the neighboring elements of the FSS. The varactor devices may be of any type and include semiconductor diodes, ferroelectric devices (barium strontium titanate or BST), micro electromechanical systems (MEMS) devices, liquid crystal devices, phase change elements, and others. On other circuit layers, control lines are printed or otherwise created that connect the varactor devices to the analog control sources. These control lines are placed parallel to the FSS patch pattern to minimize effects upon the radiation pattern or, if designed carefully, to enhance performance of the electronically tuned FSS.

The control sources (i.e., +/−V1 coarse phase control source 460 and +/−V2 coarse phase control source 465) apply analog or DC voltages or currents to the varactor devices along two orthogonal directions of FSS 400 or FSS 499. One control source controls the gradient of the phase between FSS elements along one direction of the FSS (nominally referred to as the horizontal direction) while the other controls the phase gradient along the other orthogonal direction (nominally referred to as the vertical).

The control voltage or current at each varactor forces an electrical phase delay between neighboring FSS metal patch elements. This phase delay between elements results in a phase progression or gradient along the length of the overall surface causing a change in direction of the EM waves passing through the surface. Therefore, controlling the varactors along orthogonal directions provides adjustment of the phase progression and antenna pattern in two dimensions (azimuth and elevation).

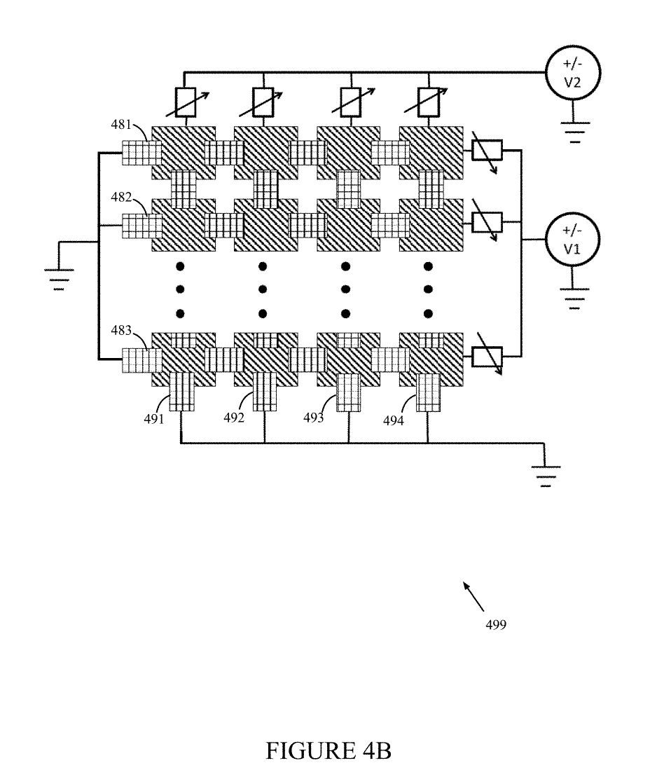

FIG. 5 illustrates a side view of radome 500 with sections of constant phase according to one embodiment of the disclosure. Radome 500 is similar to radome 100 and implements a plurality of frequency selective surfaces similar to FSS 400 in FIG. 4A and/or FSS 499 in FIG. 4B.

To simplify the design of the control lines to the varactor devices, several embodiments of FSS 400 or 499 may be implemented. In one embodiment, FSS elements are grouped together having the same phase within the group but with phase differences between groups. These groups may be defined by sectors, quadrants, or octants of the radome surface. By way of example, in FIG. 5, the surface of radome 500 is divided into eight sections (or octants) labeled φ1 through φ8. In another embodiment, phase progression occurs along one dimension only. FSS elements along the circumference (or ring) of radome 500 have a common analog control. However, the phase between rings of FSS elements are set to different values, thereby giving a cylindrically symmetric but axially controlled antenna pattern.

To simplify control, sections of constant phase may be defined. For slow changing sections of the radomes outer profile (e.g., φ1, φ2), the constant phase sections may be large. For areas where the envelope of the radome is changing faster, finer or smaller sections (e.g., φ7, φ8) may be used.

The operation of the plurality of FSS 400 in radome 500 is illustrated by the directed beams that propagate with flat phase fronts in FIG. 5. Flat phase front 510 is comprised of a plurality of phase-compensated beams, including exemplary beams 511 and 512. These beams are formed by a plurality of FSS 400 implemented in sections φ7, φ5, φ3, and φ1. Flat phase front 520 is comprised of a plurality of phase-compensated beams, including exemplary beams 521 and 522. These beams are formed by a plurality of FSS 400 implemented in sections φ8, φ6, φ4, and φ2. Flat phase front 520 is comprised of a plurality of phase-compensated beams, including exemplary beams 531 and 532. These beams are formed by a plurality of FSS 400 implemented in sections φ1 through φ7.

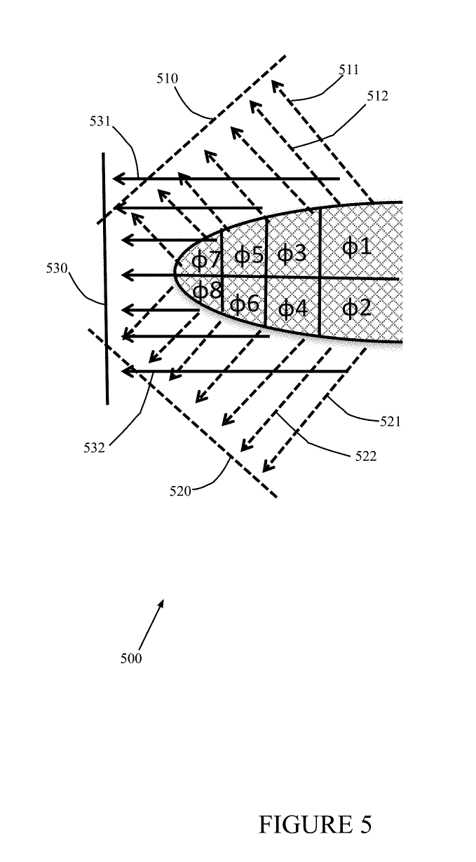

FIG. 6A illustrates distortion by an arbitrarily shaped radome that does not implement compensation. Initially, antenna pattern 611 is generated within uncompensated radome 612. However, after the antenna beams pass through radome 612, the result is distorted radiation pattern 613.

FIG. 6B illustrates distortion by an arbitrarily shaped radome that implements compensation according to the principles of the present disclosure. Initially, antenna pattern 621 is generated within compensated radome 622. However, a plurality of electronically controlled FSS 630, each of which is similar to FSS 400, are implemented in radome 622 and provide phase compensation that counters the effects of distortion caused by the radome shape. The result is undistorted radiation pattern 623 which is very similar to initial antenna pattern 621.

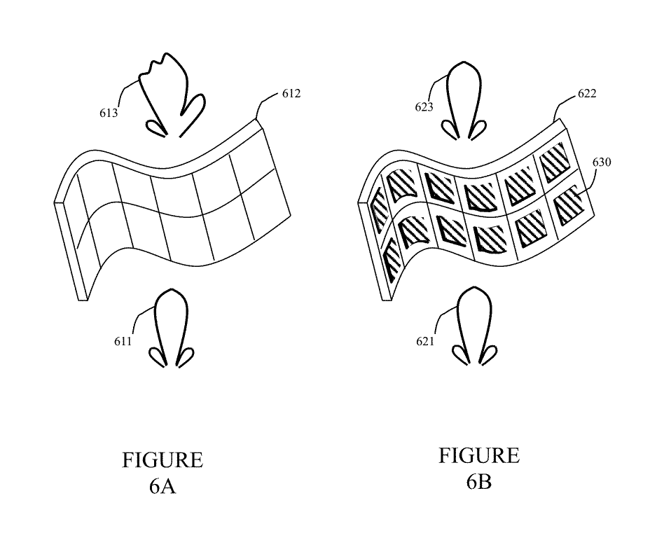

FIG. 7 is a graph of phase as a function of frequency and voltage for a reflect array design according to the principles of the present disclosure.

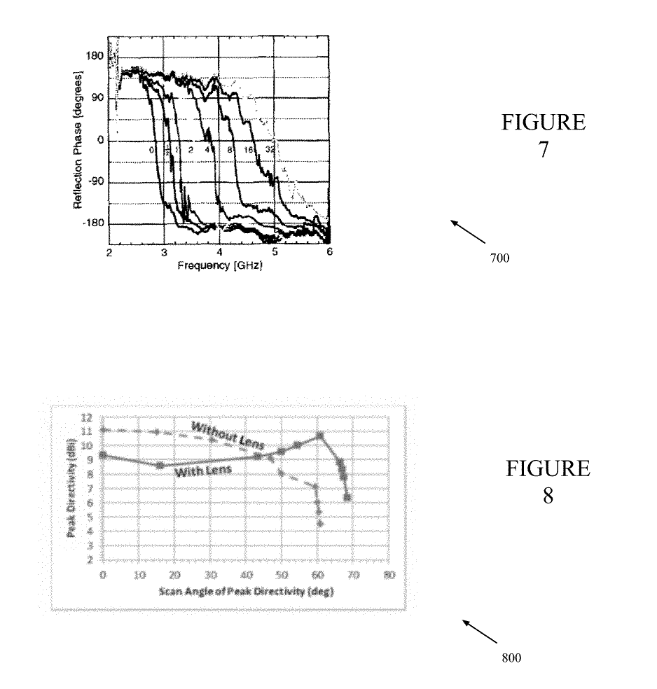

FIG. 8 depicts graph 800, which illustrates a comparison of peak directivity with and without passive FSS showing a scanning range larger than that of an array alone according to the principles of the present disclosure.

Advantageously, in the disclosed apparatus, the antenna array and the electronically controlled FSS are independent elements that may be independently optimized. Alternatively, the tuned FSS provides additional degrees of freedom to optimize EM radiation characteristics of the combined antenna and radome.

Where complex weighting of antenna elements alone does not sufficiently compensate beam-shape distortion by radomes, the disclosed electronically controlled FSS provides a method to correct such distortions. The method allows the use of multiple different antenna models with a single radome product or multiple different radome models with a single antenna model without a need to redesign or re-calibrate the antenna for effects of the radome on beam-shape.

The maximum scanning range of a planar electronically steered or phased antenna array is limited. At beam scanning angles approaching angles parallel to the antenna array plane, antenna directivities are significantly lower than those at angles perpendicular to the array plane. The disclosed FSS device increases radar beam scanning ranges to values beyond limits with current planar electronic scanning arrays.

The disclosed apparatus and method extend the previously proven passive method in the following ways: i) active electronic control of the FSS; ii) integration of the electronically controlled FSS into a radome; iii) formation of the electronically controlled FSS into shapes other than a plane and conformal to radar radomes (e.g., sections of a prolate ellipsoid or nosecone); iv) active control of the maximum scan angle over a wide frequency range. The degree of phase change across the FSS surface changes for different frequencies if the beam shape is to be maintained at maximum scan angles.

For many airborne radar applications, antenna array sizes are too large. Aerodynamics demand small forward cross-sections while antenna apertures demand large cross-sections. The aperture size (or gain) of a small antenna may be significantly increased by placing a passive planar FSS configured as a microwave lens ahead of the antenna [6]. The gain from a single antenna element can approach that of an array having an aperture equivalent in size to that of the lens. High gain antenna beam-steering or scanning have also been demonstrated for small antenna arrays used in conjunction with planar microwave lenses. The disclosed FSS uses the capability of passive planar microwave lenses to provide high-gain electronic beam scanning using either a single antenna element or a small number or single antenna elements. The disclosed FSS significantly reduces the size and complexity of the antenna array and, effectively, places the antenna aperture on the inside surface of the radome where usable space may be more readily available.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a radome, an apparatus for compensating for distortions in radio frequency (RF) beams caused by the radome, the apparatus comprising:
a plurality of metal patches arranged in rows and columns;
a first plurality of varactors coupling adjoining ones of a first plurality of metal patches in a first row of metal patches; and
a first reference voltage source configured to apply a first reference voltage to the first plurality of metal patches in the first row,
wherein the first reference voltage source adjusts the phase delay of a portion of an RF beam passing through each of the first plurality of metal patches in the first row by controlling a voltage or a current at each varactor to thereby generate electrical phase delays between the adjoining ones of the first plurality of metal patches in the first row.

2. The apparatus as set forth in claim 1, further comprising a first row fine phase step controller configured to couple a first one of the first plurality of metal patches in the first row to the first reference voltage source.

3. The apparatus as set forth in claim 2, wherein the first row fine phase step controller comprises a variable resistor.

4. The apparatus as set forth in claim 2, further comprising a second row fine phase step controller configured to couple a second one of the first plurality of metal patches in the first row to a ground.

5. The apparatus as set forth in claim 4, wherein the second row fine phase step controller comprises a variable resistor.

6. The apparatus as set forth in claim 1, wherein further comprising:
a second plurality of varactors coupling adjoining ones of a second plurality of metal patches in a first column of metal patches; and
a second reference voltage source configured to apply a second reference voltage to the second plurality of metal patches in the first column,
wherein the second reference voltage source adjusts the phase delay of a portion of an RF beam passing through each of the second plurality of metal patches in the first column by controlling a voltage or a current at each varactor to thereby generate electrical phase delays between the adjoining ones of the second plurality of metal patches in the first column.

7. The apparatus as set forth in claim 6, further comprising a first column fine phase step controller configured to couple a first one of the second plurality of metal patches in the first column to the second reference voltage source.

8. The apparatus as set forth in claim 7, wherein the first column fine phase step controller comprises a variable resistor.

9. The apparatus as set forth in claim 7, further comprising a second column fine phase step controller configured to couple a second one of the second plurality of metal patches in the first column to a ground.

10. The apparatus as set forth in claim 9, wherein the second column fine phase step controller comprises a variable resistor.
